(19) United States
(12) Patent Application Publication
(10) Pub. No.: US 2026/0136002 A1
(43) Pub. Date: May 14, 2026

(54) Inter-Prediction With Filtering

(71) Applicant: Google LLC, Mountain View, CA (US)

(72) Inventors: Xiang Li, Saratoga, CA (US); Jianle Chen, San Diego, CA (US); Debargha Mukherjee, Cupertino, CA (US); Jingning Han, Santa Clara, CA (US); Yaowu Xu, Saratoga, CA (US)

(21) Appl. No.: 19/120,023

(22) PCT Filed: Dec. 16, 2022
(86) PCT No.: PCT/US2022/053152

§ 371 Date: Apr. 10, 2025

Related U.S. Application Data
(60) Provisional application No. 63/415,807, filed on Oct. 13, 2022.

(51) Int. Cl. H04N 19/117; H04N 19/159; H04N 19/176; H04N 19/80

(52) U.S. Cl. CPC H04N 19/117; H04N 19/159; H04N 19/176; H04N 19/80

(57) ABSTRACT

Decoding a current block using inter prediction with filtering includes identifying an intermediate prediction block for the current block using a motion vector and a reference frame. Filter coefficients are obtained for a filter. The filter coefficients are obtained using reconstructed pixels and second reconstructed pixels. The reconstructed pixels are peripheral to the current block. The second reconstructed pixels are peripheral to the intermediate prediction block. The filter is applied to the intermediate prediction block to obtain a final prediction block. The current block is reconstructed using the final prediction block. Encoding a current block includes obtaining an intermediate motion vector for the current block. Filter coefficients are obtained by minimizing an error metric between a prediction block corresponding to the intermediate motion vector and the current block. A motion vector is obtained for the current block by refining the intermediate motion vector using the filter coefficients.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including compression and other encoding techniques.

Encoding based on motion estimation and compensation may be performed by breaking frames or images into blocks that are predicted based on one or more prediction blocks of reference frames. Differences (i.e., residual errors) between blocks and prediction blocks are compressed and encoded in a bitstream. A decoder uses the differences and the reference frames to reconstruct the frames or images.

### SUMMARY

Disclosed herein are aspects, features, elements, and implementations for encoding and decoding blocks using segmentation-based parameterized motion models.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method for decoding a current block using inter prediction with filtering. The method also includes identifying an intermediate prediction block for the current block using a motion vector and a reference frame. The method also includes obtaining filter coefficients for a filter, where the filter coefficients are obtained using first reconstructed pixels and second reconstructed pixels, where the first reconstructed pixels are peripheral to the current block, and where the second reconstructed pixels are peripheral to the intermediate prediction block. The method also includes applying the filter to the intermediate prediction block to obtain a final prediction block. The method also includes reconstructing the current block using the final prediction block. Other embodiments of this aspect include corresponding computer systems, apparatus, and computer programs recorded on one or more computer storage devices, each configured to perform the actions of the methods. Implementations may include one or more of the following features.

The method where the filter includes more than two coefficients.

The method may include decoding an inter-prediction mode indicating to apply the filter.

The method may include applying the filter to the intermediate prediction block in response to determining that a block other than the current block is reconstructed using an inter-prediction mode indicating to apply filtering.

The method may include decoding, from a compressed bitstream, a cardinality of the filter coefficients to obtain for the filter. The cardinality of the filter coefficients can be greater than two.

Obtaining the filter coefficients for the filter may include obtaining a predicted filter coefficient for a filter coefficient of the filter coefficients; decoding, from a compressed bitstream, a coefficient refinement value; and adjusting the predicted filter coefficient using the coefficient refinement value to obtain the filter coefficient. The coefficient refinement value can be used for an intermediate prediction pixel to which the filter is applied. The coefficient refinement value can be used to refine a coefficient corresponding to a non-linear term of the filter.

The filter coefficients can be obtained by minimizing an error metric between the first reconstructed pixels and the second reconstructed pixels. The error metric can be a sum of squares error. The filter coefficients can be applied to at least a subset of pixels in a 3×3 neighborhood of an intermediate prediction pixel to obtain a prediction pixel of the final prediction block. The at least the subset of the pixels in a 3×3 neighborhood of the intermediate prediction pixel may include the intermediate prediction pixel, a pixel above the intermediate prediction pixel, a pixel right of the intermediate prediction pixel, a pixel below the intermediate prediction pixel, and a pixel left of the intermediate prediction pixel.

The filter can further include a constant component. The filter can include at least one non-linear component.

The current block can be a luminance block, and a chroma prediction block for a chroma block corresponding to the current block can be derived from the final prediction block.

A first filter shape can be used in a case that the current block is a luma block and a second filter shape that is different from the first filter shape can be used in a case that the current block is a chroma block.

One general aspect includes a method used for encoding a current block. The method also includes obtaining an intermediate motion vector for the current block. The method also includes obtaining filter coefficients by minimizing an error metric between a prediction block corresponding to the intermediate motion vector and the current block. The method also includes obtaining a motion vector for the current block by refining the intermediate motion vector using the filter coefficients. Other embodiments of this aspect include corresponding computer systems, apparatus, and computer programs recorded on one or more computer storage devices, each configured to perform the actions of the methods. Implementations may include one or more of the following features.

The method where the filter coefficients may include a first coefficient (a), a second coefficient (b), and a third coefficient (c), and refining the intermediate motion vector using the filter coefficients may include obtaining a first adjustment for a first component of the intermediate motion vector as 2*b/a; and obtaining a second adjustment for a second component of the intermediate motion vector as 2*c/a.

The method may include encoding at least one of the first adjustment or the second adjustment in a compressed bitstream.

Implementations of the described techniques may include hardware, a method or process, or computer software on a computer-accessible medium.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. For example, a non-transitory computer-readable storage medium can include executable instructions that, when executed by a processor, facilitate performance of operations operable to cause the processor to carry out any of the method described herein. Aspects can be combined such that features described in the context of one aspect may be implemented in another aspect.

Variations in and further details of these methods, techniques, and apparatuses are found in the drawings, description, and claims that follow.

### BRIEF DESCRIPTION OF THE DRAWINGS

The description herein makes reference to the accompanying drawings described below, wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of a video stream to be encoded and subsequently decoded.

FIG. 4 is a block diagram of an encoder according to implementations of this disclosure.

FIG. 5 is a block diagram of a decoder according to implementations of this disclosure.

FIG. 6 is a flowchart diagram of a technique for decoding a current block using inter prediction with filtering.

FIG. 7 illustrates an example of a template of reconstructed pixels.

FIG. 8 illustrates an example of a neighborhood of an intermediate pixel of an intermediate prediction block.

FIG. 9 illustrates an example of the locations of left and above samples and the sample of the current block involved in the cross-component filtering mode.

FIG. 10 is a flowchart diagram of a technique used for encoding a current block.

### DETAILED DESCRIPTION

As mentioned above, compression schemes related to coding video streams may include breaking images into blocks and generating a digital video output bitstream (i.e., an encoded bitstream) using one or more techniques to limit the information included in the output bitstream. A received bitstream can be decoded to re-create the blocks and the source images from the limited information. Encoding a video stream, or a portion thereof, such as a frame or a block, can include using temporal similarities in the video stream to improve coding efficiency. For example, a current block of a video stream may be encoded based on identifying a difference (residual) between the previously coded pixel values, or between a combination of previously coded pixel values, and those in the current block.

Encoding using temporal similarities is known as inter prediction. Inter prediction attempts to predict the pixel values of a block using a possibly displaced block or blocks from a temporally nearby frame (i.e., reference frame) or frames. A temporally nearby frame is a frame that appears earlier or later in time in the video stream than the frame of the block being encoded. Inter prediction can be performed using a motion vector that represents translational motion, i.e., pixel shifts of a prediction block in a reference frame in the x- and y-axes as compared to the block being predicted.

When the source data is noisy, when there are illumination differences between a current block being predicted and a reference frame used to obtain the prediction block (i.e., also known as the reference block), or when the source data include motion blur, the prediction accuracy may suffer and consequently the compression performance may also suffer.

Implementations of this disclosure remedy situations such as these by obtaining an intermediate prediction block for a current block and further filtering the pixels of the intermediate prediction block to obtain a (final) prediction block for the current block. The intermediate prediction block can be a reference block in a reference frame. Residual data (i.e., a residual block) may be obtained as a difference (i.e., pixel-wise difference) between the current block and the final prediction block. The residual data can be encoded in a compressed bitstream, as described herein. In an example, when decoding the current block, a decoder similarly applies a filter to an intermediate prediction to obtain a final prediction block, decodes the residual block from the compressed bitstream, and combines the final prediction block and the residual block to reconstruct the current block.

Given an intermediate pixel at a location (x, y) of the intermediate prediction block, the filter is used to obtain the corresponding (i.e., co-located) pixel in the prediction block. The filter can be a weighted combination of intermediate pixels in a neighborhood of the intermediate prediction pixel. Different neighborhoods can be used. The weighted combination can be a linear combination or a non-linear combination (i.e., may include at least one non-linear term). As is known, a filter uses filter coefficients as the weights of the different intermediate pixels in the neighborhood. The encoder and the decoder derive the filter coefficients using first reconstructed pixels peripheral to the current block and second reconstructed pixels peripheral to the intermediate prediction block.

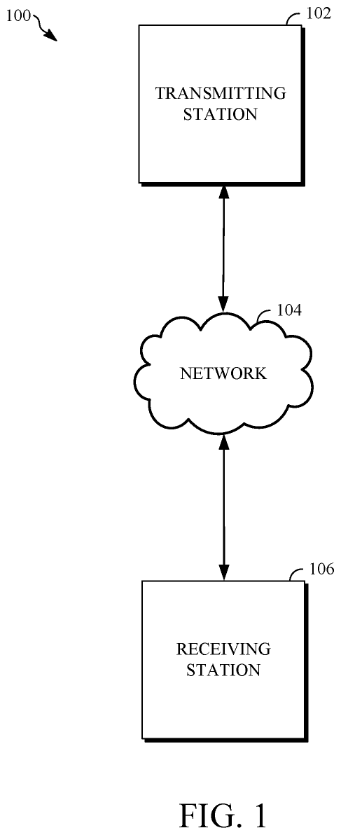

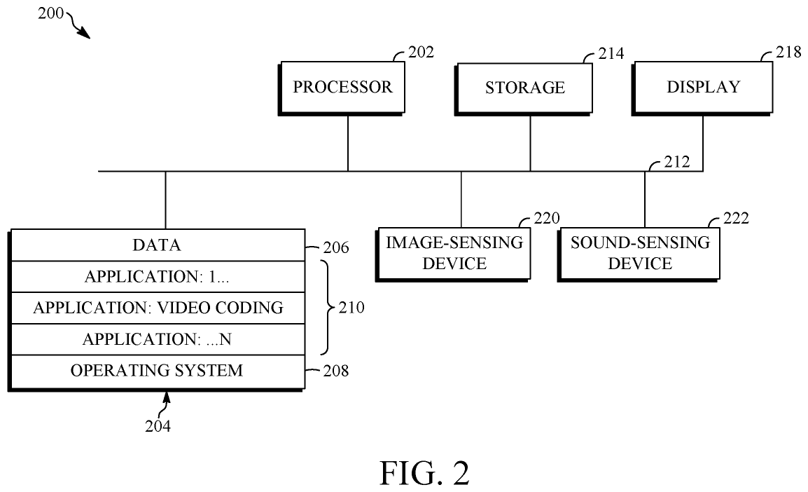

Further details of techniques for inter-prediction with filtering of a current block are described herein with initial reference to a system in which they can be implemented. FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102, and the encoded video stream can be decoded in the receiving station 106. The network 104 can be, for example, the Internet. The network 104 can also be a local area network (LAN), wide area network (WAN), virtual private network (VPN), cellular telephone network, or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a Hypertext Transfer Protocol (HTTP) video streaming protocol.

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits his or her own video bitstream to the video conference server for decoding and viewing by other participants.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A CPU 202 in the computing device 200 can be a conventional central processing unit. Alternatively, the CPU 202 can be any other type of device, or multiple devices, capable of manipulating or processing information now existing or hereafter developed. Although the disclosed implementations can be practiced with one processor as shown (e.g., the CPU 202), advantages in speed and efficiency can be achieved by using more than one processor.

A memory 204 in computing device 200 can be a read only memory (ROM) device or a random access memory (RAM) device in an implementation. Any other suitable type of storage device can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the methods described herein. For example, the application programs 210 can include applications 1 through N, which further include a video coding application that performs the techniques described here, such as the techniques for performing inter-prediction of a current block with filtering. Computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into one unit, other configurations can be utilized. The operations of the CPU 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

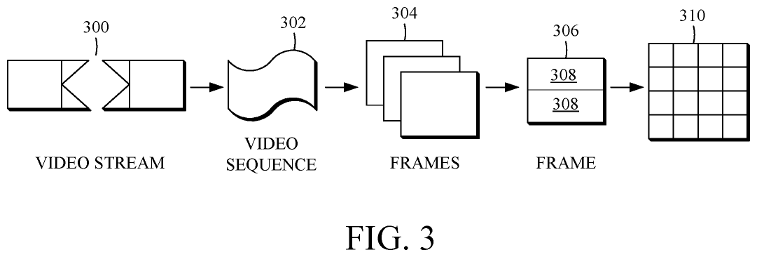

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, for example, a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macroblock are used interchangeably herein.

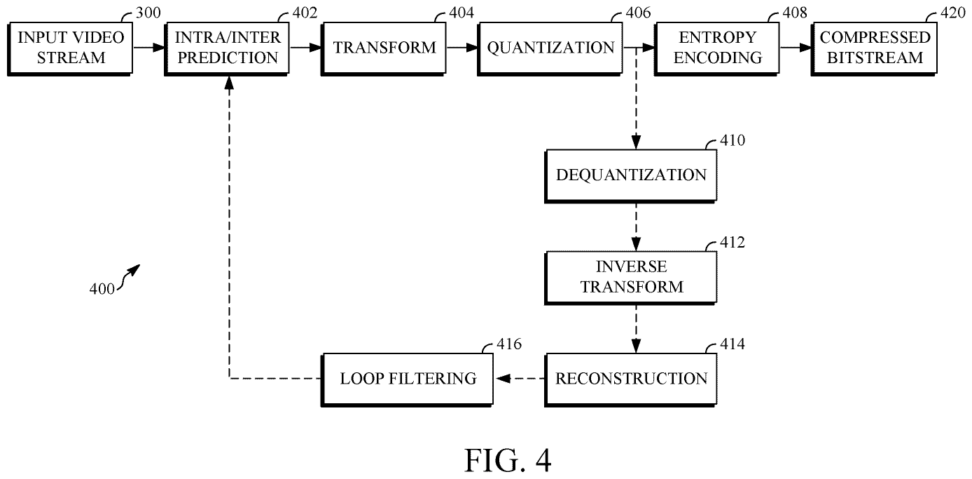

FIG. 4 is a block diagram of an encoder 400 according to implementations of this disclosure. The encoder 400 can be implemented, as described above, in the transmitting station 102, such as by providing a computer software program stored in memory, for example, the memory 204. The computer software program can include machine instructions that, when executed by a processor such as the CPU 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

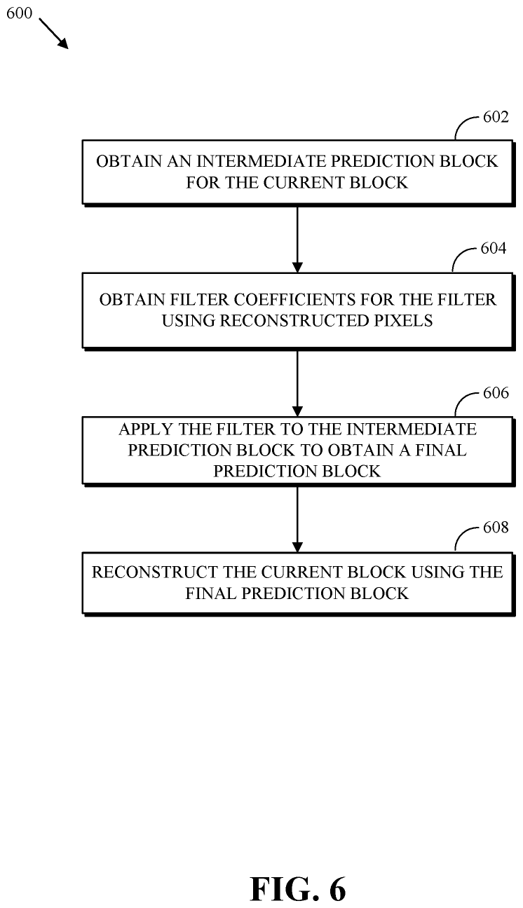

When the video stream 300 is presented for encoding, respective adjacent frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames. Implementations for forming a prediction block are discussed below with respect to FIGS. 6, 7, and 8, for example, using parameterized motion model identified for encoding a current block of a video frame.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block (which may include, for example, the type of prediction used, transform type, motion vectors and quantizer value), are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs functions that are similar to functions that take place during the decoding process (described below), including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform based encoder can quantize the residual signal directly without the transform stage 404 for certain blocks or frames. In another implementation, an encoder can have the quantization stage 406 and the dequantization stage 410 combined in a common stage.

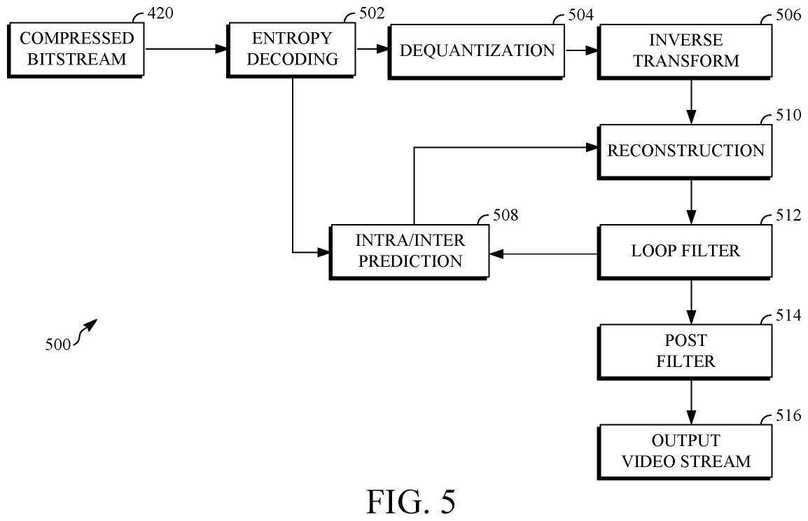

FIG. 5 is a block diagram of a decoder 500 according to implementations of this disclosure. The decoder 500 can be implemented in the receiving station 106, for example, by providing a computer software program stored in the memory 204. The computer software program can include machine instructions that, when executed by a processor such as the CPU 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512, and a post filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts.

Other filtering can be applied to the reconstructed block. In this example, the post filtering stage 514 is applied to the reconstructed block to reduce blocking distortion or perform other post-processing on a frame, and the result is output as the output video stream 516. The output video stream 516 can also be referred to as a decoded video stream, and the terms will be used interchangeably herein. Other variations of the decoder 500 can be used to decode the compressed bitstream 420. For example, the decoder 500 can produce the output video stream 516 without the post filtering stage 514.

FIG. 6 is a flowchart diagram of a technique 600 for decoding a current block using inter prediction with filtering. The technique 600 performs inter prediction with filtering. The technique 600 can be implemented in a decoder such as the decoder 500 of FIG. 5 or in the reconstruction path of FIG. 4. The technique 600 can be implemented, for example, as a software program that can be executed by computing devices such as transmitting station 102 or the receiving station 106 of FIG. 1. The software program can include machine-readable instructions (e.g., executable instructions) that can be stored in a memory such as the memory 204 or the secondary storage 214, and that can be executed by a processor, such as CPU 202, to cause the computing device to perform the technique 600. In at least some implementations, the technique 600 can be performed in whole or in part by the intra/inter prediction stage 508 of the decoder 500 of FIG. 5.

The technique 600 can be implemented using specialized hardware or firmware. Some computing devices can have multiple memories, multiple processors, or both. The steps or operations of the technique 600 can be distributed using different processors, memories, or both. Use of the terms “processor” or “memory” in the singular encompasses computing devices that have one processor or one memory as well as devices that have multiple processors or multiple memories that can be used in the performance of some or all of the recited steps.

At 602, an intermediate prediction block is identified for the current block. The current block may be a luminance block (e.g., a Y block) or a chrominance block (e.g., a Cb block, a Cr block, a U block, or a V block). The intermediate prediction block may also be referred to as a reference block. In an example, a motion vector and a reference frame may be identified for the current block. In an example, the reference block and the motion vector may be identified using data obtained from a compressed bitstream, such as the compressed bitstream 420 of FIG. 5. The motion vector and reference may be identified as described with respect to FIG. 5.

In an example, the data obtained from the compressed bitstream can indicate that a motion vector and/or a reference of another block, which may be a temporal or spatial neighboring block to the current block, are to be used for the current block. In such a situation, the current block may be said to be merged with the neighboring block. The intermediate prediction block is the block in the reference frame that is pointed to by the motion vector. As is known, the intermediate prediction block (i.e., the reference block) may be at integer pixel locations or at sub-pixel locations. In the case that the intermediate prediction block is at sub-pixel locations, and as is known, interpolation filtering may be performed to obtain values at the sub-pixels.

At 604, filter coefficients are obtained for a filter. The filter coefficients are obtained using first reconstructed pixels and second reconstructed pixels. The first reconstructed pixels are peripheral to the current block; and the second reconstructed pixels are peripheral to the intermediate prediction block. The set of reconstructed pixels used may be referred to as a template. As such, the first reconstructed pixels may also be referred to as a current block template; and the second reconstructed pixels may also be referred to as a reference block template. Whether the intermediate prediction block is at integer location or sub-pixel locations, the second reconstructed pixels (i.e., the reference block template) are at integer locations.

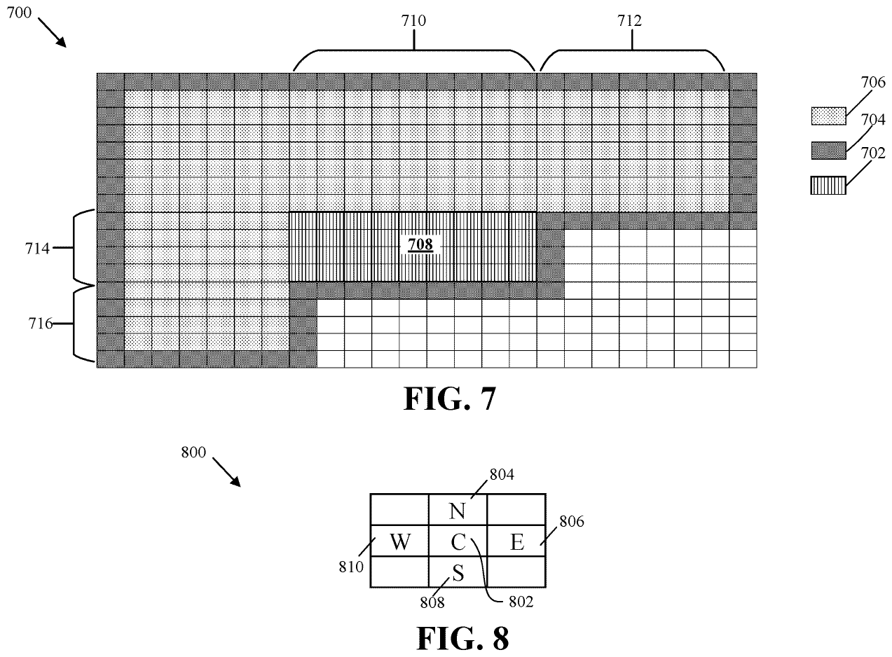

FIG. 7 illustrates an example 700 of a template of reconstructed pixels. The example 700 illustrates pixels that are filled with different patterns. The example 700 is used to illustrate a current block template and is also used to illustrate a reference block template.

When used to describe a current block template, a block 708 illustrates a current block (i.e., the block being decoded). While the block 708 is shown as being of size 8×4, the disclosure is not so limited. The block 708 can be of any other size. Pixels filled with a pattern 702 are pixels of the current block of a current frame. Pixels filled with a pattern 706 (or a subset thereof, as further described herein) illustrate reconstructed pixels of the current frame. Pixels filled with a pattern 704 are pixels that are not available and may contain a padding value (i.e., are set to a padding value). Depending on the neighborhood used for a filter, one or more pixels used by the filter may not be available (such as because these pixels are outside the frame boundary or are outside a largest coding unit that includes the block 708). As such, a padding value may be used (e.g., assumed) for such pixels.

When used to describe a reference block template, the block 708 illustrates a reference block in a reference frame. Again, while the block 708 is shown as being of size 8×4, the disclosure is not so limited. The block 708 can be of a size corresponding to the size of the current block. As such, pixels filled with the pattern 702 are pixels of the reference block of a reference frame. Pixels filled with the pattern 706 (or a subset thereof, as further described herein) illustrate reconstructed pixels of the reference frame. Pixels filled with the pattern 704 are pixels that are not available and may contain a padding value.

The template may include a top region 710 that may include 1 to N (where N>1) rows of pixels. The template may include a top-right region 712 that includes 1 to N rows. The template may include a left region 714 of 1 to M (where M>1) columns of pixels. The template may include a bottom-left region 716 of 1 to M (where M>1) columns of pixels.

In an example, N=M. In an example, if the current block is a luma block, then the template can be 4-sample wide. If the current block is a chroma block, the template (i.e., a chroma template) may be based on the chroma color format. For example, for 4:4:4 content, the chroma template can also be 4-sample wide; and for 4:2:0 or 4:2:2 color formats, the chroma template can be 2-sample wide. In an example, when the top-right region 712 is available, only a 4×4 luma block at the top-right is included in the template. Similarly, if the bottom-left region 716 is available, only a 4×4 luma block at bottom-right is included in the template. The chroma template can be adjusted accordingly based on the chroma color format. In another example, the top template may always be 1-sample wide for both luma and chroma while the left template may be 4-sample wide for luma.

Referring again to FIG. 6, in an example, the filter coefficients include at least two coefficients. In an example, the filter coefficients include more than two coefficients for at least one of the color components (i.e., at least of the luma or the chroma component). In an example, the number (i.e., cardinality) of the filter coefficients can be decoded from the compressed bitstream. For example, an indicator of the number of filter coefficients can be decoded from the compressed bitstream. For example, in response to the indicator of the number of the filter coefficients being a first value (e.g., 0), the technique 600 may not be performed for the current block. That is, if the indicator of the number of coefficient is the first value, then no filtering is performed on the prediction block. If the indicator of the number of the filter coefficients is a second value (e.g., 1), then two filter coefficients are derived; and if the indicator of the number of filter coefficients is a third value (e.g., 2), then more than two filter coefficients are derived.

When the number of the filter coefficients is second value (e.g., when the indicator of the number of filter coefficients is two), the two filter coefficients may be obtained using a technique known as Local Illumination Compensation (LIC). LIC is described in U.S. Patent Publication No. 2021/0352309, which is incorporated herein by reference. Briefly, LIC is an inter prediction technique to model local illumination variations between a current block and its prediction block as a function of illumination between a current block template and a reference block template. The parameters of the function can be denoted by a scale α and an offset β, therewith forming a linear equation: α×p[x]+β to compensate for illumination changes, where p[x] is a reference sample pointed to by a motion vector (MV) at a location x in the reference frame. As α and β can be derived based on the current block template and the reference block template, no signaling overhead is required for them. That is, an encoder need not encode and the decoder need not decode values for the α and β parameters.

In an example, the filter can be a convolutional filter. The filter coefficients can be obtained by minimizing an error metric between the first reconstructed pixels and the second reconstructed pixels. The error metric can be a mean square error (MSE) between pixel values of the respective reconstructed pixels. The error can be a sum of absolute differences (SAD) error between the pixel values of the reconstructed pixels. Any other suitable error metric can be used.

In an example, the number of coefficients to be obtained depends on which pixels within the neighborhood of the intermediate prediction pixel to which the filter is to be applied are used in the filtering. The pixels within the neighborhood of an intermediate prediction pixel that are used for filtering are referred to herein as at least a subset of pixels of the neighborhood. FIG. 8 illustrates an example 800 of a neighborhood of an intermediate pixel 802 of an intermediate prediction block. The example 800 illustrates a 3×3 neighborhood. However, the neighborhood can be larger or smaller, rectangular, or some other shape (e.g., diamond). The example 800 illustrates that pixels 804-810 (i.e., pixels to the north, east, south, and west of the intermediate pixel 802, respectively) are used in the filtering. As such, the filter coefficients include at least five coefficients: one coefficient to be used with each of the pixels 802-810.

As such, the filter is a 5-tap filter and the prediction pixel corresponding to the intermediate pixel 802 can be obtained using equation (1), where cᵢ (i=0, . . . , 4) are the filter coefficients, pred is the filter pixel of the final prediction block. Equation (1) is shown as further including a constant term (i.e., c₅), which may also be derived and used ins some implementations.

$$pred = {c}_{0} C + {c}_{1} N + {c}_{2} S + {c}_{3} E + {c}_{4} W + {c}_{5} \qquad ( 1 )$$

In an example, one or more but not all filter coefficients may be further refined after being derived. As such, the obtained filter coefficients may be considered to be predicted filter coefficients. The difference (i.e., a coefficient refinement value) between a predicted filter coefficient and the actual value of the filter coefficient may be signaled in the compressed bitstream. As such, obtaining the filter coefficients for the filter can include obtaining a predicted filter coefficient for a filter coefficient of the filter coefficients; decoding, from the compressed bitstream, a coefficient refinement value; and adjusting the predicted filter coefficient using the coefficient refinement value to obtain the filter coefficient.

In an example, the coefficient refinement value corresponds (i.e., is used for) the intermediate prediction pixel itself. That is, for example, the coefficient refinement value may be used to refine the filter coefficient obtained for the intermediate pixel 802 of FIG. 8. As such, the coefficient refinement value is used for an intermediate prediction pixel to which the filter is applied. In an example, the coefficient refinement value can be used to refine a coefficient corresponding to a non-linear term of the filter. For example, the filter may include a filter coefficient corresponding to the intermediate prediction pixel, one non-linear term, and a constant value. The non-linear term (i.e., a non-linear component) can be a square term of the intermediate prediction pixel. As such, the filter can be given by a×p[x]²+b×p[x]+c, where a and b are the filter coefficients, c is a constant component, and p[x] is the value of the intermediate prediction pixel at location x.

In an example, and as described with respect to FIG. 8, the filter coefficients can be applied to at least a subset of pixels in a 3×3 neighborhood of an intermediate prediction pixel to obtain the prediction pixel of the final prediction block. A 3×3 neighborhood can be used whether the current block is a luma block or a chroma block. The subset of the pixels can form (e.g., can be of any) shape. In an example, the subset of the pixels in a 3×3 neighborhood can be those pixels that form a cross shape, such as shown in FIG. 8. That is the subset of the pixels can be the pixels 802-810. That is, the at least a subset of pixels in a 3×3 neighborhood of an intermediate prediction pixel can be or include the intermediate prediction pixel, a pixel above the intermediate prediction pixel, a pixel right of the intermediate prediction pixel, a pixel below the intermediate prediction pixel, and a pixel left of the intermediate prediction pixel.

In an example, the filter can use at least a subset of pixels in a 3×3 neighborhood and may further include a constant term (also referred to as a DC value). In an example, one shape (i.e., a first filter shape) may be used for the at least the subset of pixels in the neighborhood for a current block that is a luma block than a second filter shape may be used for a current block that is a chroma block. As such, a first filter shape may be used in a case that the current block is a luma block and a second filter shape that is different from the first filter shape may be used in a case that the current block is a chroma block.

At 606, the filter is applied to the intermediate prediction block to obtain a final prediction block. At 608, the current block is reconstructed using the final prediction block. In an example, a residual block may be decoded from the compressed bitstream and added to the final prediction block to obtain the current block.

In an example, cross-component filtering may be applied. That is, the prediction obtained for a luma block can be used to obtain the prediction for a chroma block. Said another way, in the case that the current block is a luma block, a chroma prediction block for a chroma block corresponding to the current block is derived from the final prediction block. As such, in a case that the current block is a luma block, the technique 600 can further include obtaining a chroma prediction block from the final prediction block. In an example, a 3×3 luma filter plus 1×1 chroma filter plus a DC value may be used. Alternatively, a 3×3 luma filter plus 3×3 chroma filter plus a DC value may be used.

Cross-component filtering can be similar to the cross-component filtering described in U.S. Patent Publication No. 2022/0272351, which is incorporated herein by reference. To summarize, in cross-component filtering, chroma samples are predicted based on the reconstructed luma samples of the same coding unit (which may be referred to as a largest coring unit, a macroblock, or other such nomenclature) of the current block by using a linear model that is according to equation (2):

$$p r e {d}_{c} ( i , j ) = α \times {rec}_{l}^{′} ( i , j ) + β \qquad ( 2 )$$

In equation (2), pred_{c}(i,j) represents the chroma sample predictions, rec^{l}′(i,j) represents a down-sampled reconstructed luma predictions of the current luma block. Down-sampling is performed in the case that the chroma samples and the luma samples do not have the same resolution. For example, down-sampling may be performed in that case that a 4:2:2 or a 4:2:0 format is used. The down-sampling aligns the resolution of luma and chroma blocks.

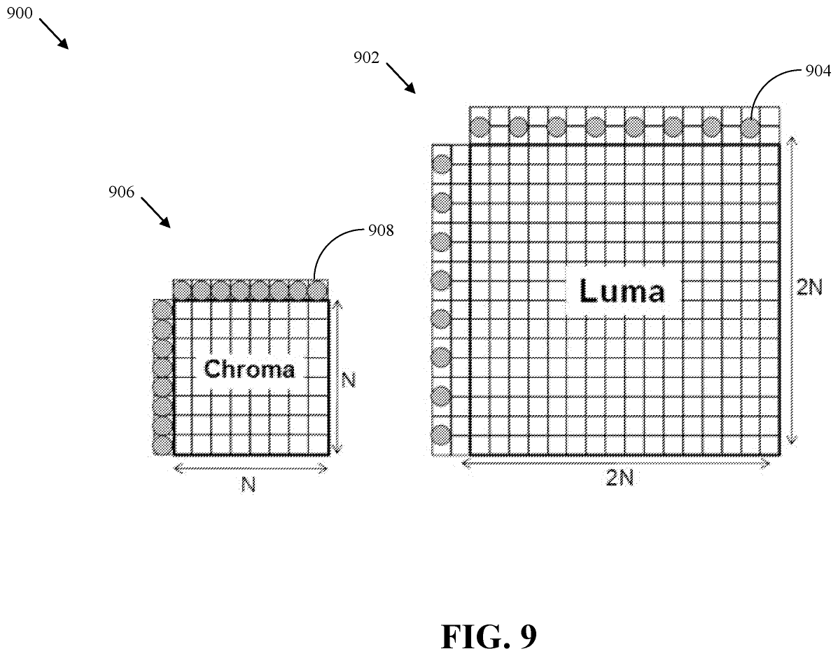

The cross-component parameters (α and β) can be derived with at most four neighboring chroma samples and their corresponding down-sampled luma samples. FIG. 9 illustrates an example 900 of the locations of left and above samples and the sample of the current block involved in the cross-component filtering mode. The division operation to calculate parameter a may be implemented with a look-up table. With respect to a luma block 902, the locations of left and above samples are shown as filled circles, such as a filled circle 904. With respect to a chroma block 906, the locations of left and above samples are shown as filled circles, such as a filled circle 908.

In another example, a 7-tap convolutional filter may be used to obtain the chroma prediction block from a luminance prediction block. The convolutional filter may include a 5-tap plus sign shape spatial component, a nonlinear term, and a bias term. The input to the spatial 5-tap component of the filter consists of a center (C) luma sample which is collocated with the chroma sample to be predicted and its above/north (N), below/south (S), left/west (W) and right/east (E) neighbors, as described above with respect to equation (1). As such, the prediction pixel can be obtained using equation (3):

$$predChromaVal = {c}_{0} C + {c}_{1} N + {c}_{2} S + {c}_{3} E + {c}_{4} W + {c}_{5} P + {c}_{6} B \qquad ( 3 )$$

In equation (3), P is the non-linear term. In an example, the nonlinear term P can be represented as power of two of the center luma sample C (i.e., intermediate pixel 802) and scaled to the sample value range of the content: P=(C²+midVal)>>bitDepth. To illustrate, assuming 10-bit content, then P is calculated as P=(C²+512)>>10. Other non-linear terms are possible. The bias term B, when used, can represent a scalar offset between the input and output. The coefficients cᵢ can be obtained in a similar way as described above with respect to equation (1). For example, The coefficients cᵢ can be obtained by minimizing MSE between predicted and reconstructed chroma samples in a reference area. In equation (3), C, N, S, E. and W correspond to the values of the luma prediction values, such as shown in FIG. 8.

While not specifically shown in FIG. 6, the technique 600 may be determined to perform in response to decoding from a compressed bitstream one or more syntax elements indicating that the technique 600 is to be performed. As such, in an example, the technique 600 may include decoding an inter-prediction with filtering mode (i.e., a mode that indicates to the decoder to apply filtering to a (intermediate) prediction block obtained using inter-prediction). The inter-prediction with filtering mode may be decoded from a compressed bitstream.

In another example, the technique 600 is performed for the current block if the block is merged with a block that used inter prediction with filtering. As such, in an example, inter-prediction with filtering may be performed for the current block in response to determining that a block other than the current block is reconstructed using an inter-prediction with filtering mode. Said another way, the filter is applied to the intermediate prediction block in response to determining that a block other than the current block is reconstructed using an inter-prediction mode indicating to apply filtering. More generally, the technique 600 is performed for the current block in response to determining that one or more of spatial and/or temporal neighbors of the current block were predicted using the inter-prediction with filtering mode.

In an example, an indicator may be signaled (e.g., encoded) in the compressed bitstream indicating that inter prediction with filtering is allowed at a block level. If the indicator indicated that inter prediction with filtering is not allowed at the block level, then the technique 600 would be performed for the current block. The indicator may be signaled for a group of blocks. That is, the indicator can be signaled in a header corresponding to the group of blocks. The group of blocks can be a group of frames, a frame, a segment of blocks, a tile of blocks, or a super-block. More generally, the group of blocks can be any structure that is used for packetizing data and that provides identifying information for the contained data. In an example, the indicator can be signaled at sequence level in sequence parameter set (SPS).

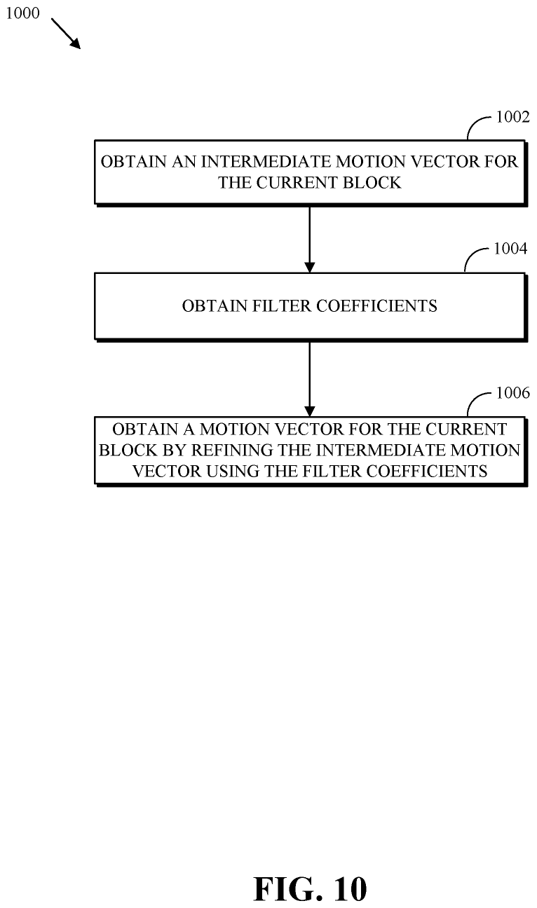

FIG. 10 is a flowchart diagram of a technique 1000 used for encoding a current block. The technique 1000 can be implemented in an encoder such as the encoder 400 of FIG. 4. The technique 1000 can be used to obtain (e.g., find, identify, etc.) a motion vector for weighted inter prediction (i.e., inter prediction with filtering) as described above. The technique 1000 can refine a motion vector obtained for the current block.

The technique 1000 can be implemented, for example, as a software program that can be executed by computing devices such as transmitting station 102. The software program can include machine-readable instructions (e.g., executable instructions) that can be stored in a memory such as the memory 204 or the secondary storage 214, and that can be executed by a processor, such as CPU 202, to cause the computing device to perform the technique 1000. In at least some implementations, the technique 1000 can be performed in whole or in part by the intra/inter prediction stage 402 of the encoder 400 of FIG. 4.

The technique 1000 can be implemented using specialized hardware or firmware. Some computing devices can have multiple memories, multiple processors, or both. The steps or operations of the technique 1000 can be distributed using different processors, memories, or both. Use of the terms “processor” or “memory” in the singular encompasses computing devices that have one processor or one memory as well as devices that have multiple processors or multiple memories that can be used in the performance of some or all of the recited steps.

At 1002, an intermediate motion vector can be obtained for the current block. The intermediate motion vector can be a motion vector that is obtained using any technique for identifying a motion vector for the current block, such as those described with respect to the intra/inter prediction stage 402 of FIG. 4. For example, and as is known, a motion vector may be identified by performing motion compensation search in search regions of one or more reference frames to identify a closest matching reference block in one of the reference frames. However, other ways of identifying the intermediate motion vector are possible.

At 1004, filter coefficients are obtained by minimizing an error metric between a prediction block (i.e., a reference block) corresponding to (i.e., referenced or pointed to) the intermediate motion vector and the current block (i.e., a source block). The error metric can be the sum of squares error (SSE). Four independent filter coefficients can be obtained. Using the example 800 to illustrate, a first coefficient (denoted a) may be derived for a center pixel (i.e., the intermediate pixel 802), a second coefficient (denoted b) may be derived for the above pixel (i.e., the pixel 804), a complement of the second coefficient (i.e., −b) can be used for the below pixel (i.e., the pixel 808), a third coefficient (denoted c) may be derived for the left pixel (i.e., the pixel 810), and a complement of the fourth coefficient (i.e., −c) can be used for the right pixel (i.e., the pixel 806). The fourth coefficient is merely a DC constant value (denoted d).

At 1006, a motion vector is obtained for the current block by refining the intermediate motion vector using the filter coefficients. That is, a motion vector refinement relative to the current MV is derived based on the filter coefficients. In an example, the motion vector refinement can be obtained using equations (4):

$${dMV}_{x} = 2 \frac{c}{a} , {dMV}_{y} = 2 \frac{b}{a} \qquad ( 4 )$$

The technique 1000 can further include encoding the motion vector in a compressed bitstream, such as the compressed bitstream 420 of FIG. 4. Any technique for encoding the motion vector can be used. In an example, a prediction of the motion vector is obtained. In such a case, encoding the motion vector in the compressed bitstream includes encoding a difference between the motion vector and the prediction of the motion vector in the compressed bitstream. To illustrate, the intermediate motion vector may be (MVₓ, MV_{y}) and the motion vector refinement is (dMVₓ, dMV_{y}). Thus, the motion vector that is encoded in the compressed bitstream is (MVₓ+dMVₓ, MV_{y}+dMV_{y}).

For simplicity of explanation, the techniques 600 and 1000 are depicted and described as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a method in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A: X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general purpose computer or general purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102, using an encoder 400, can encode content into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device, and/or a device including an encoder 400 may also include a decoder 500.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or semiconductor device. Other suitable mediums are also available.

The above-described embodiments, implementations, and aspects have been described in order to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law so as to encompass all such modifications and equivalent arrangements.

1. A method for decoding a current block using inter prediction with filtering, comprising:
identifying an intermediate prediction block for the current block using a motion vector and a reference frame;
obtaining filter coefficients for a filter, wherein the filter coefficients are obtained using first reconstructed pixels and second reconstructed pixels,
wherein the first reconstructed pixels are peripheral to the current block, and
wherein the second reconstructed pixels are peripheral to the intermediate prediction block;
applying the filter to the intermediate prediction block to obtain a final prediction block; and
reconstructing the current block using the final prediction block.

2. (canceled)

3. The method of claim 1, comprising:
decoding an inter-prediction mode indicating to apply the filter.

4. The method of claim 1, comprising:
applying the filter to the intermediate prediction block in response to determining that a block other than the current block is reconstructed using an inter-prediction mode indicating to apply filtering.

5. The method of claim 1, comprising:
decoding, from a compressed bitstream, a cardinality of the filter coefficients to obtain for the filter.

6. (canceled)

7. The method of claim 1, wherein obtaining the filter coefficients for the filter comprises:
obtaining a predicted filter coefficient for a filter coefficient of the filter coefficients;
decoding, from a compressed bitstream, a coefficient refinement value; and
adjusting the predicted filter coefficient using the coefficient refinement value to obtain the filter coefficient.

8. The method of claim 7, wherein the coefficient refinement value is used for an intermediate prediction pixel to which the filter is applied.

9. The method of claim 7, wherein the coefficient refinement value is used to refine a coefficient corresponding to a non-linear term of the filter.

10. The method of claim 1, wherein the filter coefficients are obtained by minimizing an error metric between the first reconstructed pixels and the second reconstructed pixels.

11. (canceled)

12. The method of claim 1, wherein the filter coefficients are applied to at least a subset of pixels in a 3×3 neighborhood of an intermediate prediction pixel to obtain a prediction pixel of the final prediction block.

13. The method of claim 12, wherein the at least the subset of the pixels in a 3×3 neighborhood of the intermediate prediction pixel comprise the intermediate prediction pixel, a pixel above the intermediate prediction pixel, a pixel right of the intermediate prediction pixel, a pixel below the intermediate prediction pixel, and a pixel left of the intermediate prediction pixel.

14. The method of claim 1, wherein the filter further includes a constant component.

15. The method of claim 1, wherein the filter includes at least one non-linear component.

16. The method of claim 1, wherein:
the current block is a luminance block, and
a chroma prediction block for a chroma block corresponding to the current block is derived from the final prediction block.

17. The method of claim 1, wherein a first filter shape is used in a case that the current block is a luma block and a second filter shape that is different from the first filter shape is used in a case that the current block is a chroma block.

18. A method used for encoding a current block, comprising:
obtaining an intermediate motion vector for the current block;
obtaining filter coefficients by minimizing an error metric between a prediction block corresponding to the intermediate motion vector and the current block; and
obtaining a motion vector for the current block by refining the intermediate motion vector using the filter coefficients.

19. The method of claim 18, wherein:
the filter coefficients comprise a first coefficient (a), a second coefficient (b), and a third coefficient (c), and
refining the intermediate motion vector using the filter coefficients comprises:
obtaining a first adjustment for a first component of the intermediate motion vector as 2*b/a; and
obtaining a second adjustment for a second component of the intermediate motion vector as 2*c/a.

20. The method of claim 19, comprising:
encoding at least one of the first adjustment or the second adjustment in a compressed bitstream.

21. A device, comprising:
a configured to execute the method of claim 1.

22. A device, comprising:
a memory; and
a processor, wherein the memory stores instructions operable to cause the processor to carry out the method of claim 18.

23. A non-transitory computer-readable storage storing an encoded bitstream arranged for decoding a current block according to operations comprising:
identifying an intermediate prediction block for the current block using a motion vector and a reference frame;
obtaining filter coefficients for a filter, wherein the filter coefficients are obtained using first reconstructed pixels and second reconstructed pixels,
wherein the first reconstructed pixels are peripheral to the current block, and
wherein the second reconstructed pixels are peripheral to the intermediate prediction block;
applying the filter to the intermediate prediction block to obtain a final prediction block; and
reconstructing the current block using the final prediction block.
